(19) United States
(12) Patent Application Publication
(10) Pub. No.: US 2024/0397852 A1
(43) Pub. Date: Dec. 5, 2024

(54) Wedge

(71) Applicant: Precision Planting LLC, Tremont, IL (US)

(72) Inventors: Jeremy J. Hodel, Morton, IL (US); Paul Wildermuth, Tremont, IL (US)

(21) Appl. No.: 18/691,170

(22) PCT Filed: Oct. 10, 2022
(86) PCT No.: PCT/IB2022/059681

§ 371 Date: Mar. 12, 2024

Related U.S. Application Data
(60) Provisional application No. 63/262,417, filed on Oct. 12, 2021.

(51) Int. Cl. A01C 5/06

(52) U.S. Cl. CPC A01C 5/064

(57) ABSTRACT

A trench opener having a row unit comprising a frame and a shank; a disc rotatingly attached to the frame, wherein the disc has an angle α from vertical greater than zero degrees to 10 degrees; a wedge attached to the shank, the wedge having a disc facing side that is parallel with the disc, a second side opposite the disc facing side, wherein the second side is perpendicular to a ground surface, and a leading edge.

### CROSS REFERENCE TO RELATED APPLICATIONS

This application claims priority to U.S. Application No. 63/262,417, filed 12 Oct. 2021, which is incorporated herein by reference in its entirety.

### BACKGROUND

There are various ways to form a furrow for planting seeds. Typical methods include a double disc opener on a row unit for creating a v-shaped trench (such as for planter row units), a single disc opener (such as for seeder row units), and seed boots. These methods typically create a wide trench to accept a seed deposited from a seed tube.

### BRIEF DESCRIPTION OF THE DRAWINGS

FIG. 1 is a perspective view of a row unit with an opener disc and wedge.

FIG. 2 is a right side elevation view of the row unit of FIG. 1.

FIG. 3 is a rear elevation view of the row unit of FIG. 1.

FIG. 4 is a front elevation view of the row unit of FIG. 1.

FIG. 5 is a close up perspective view of the disc and wedge of FIG. 1.

FIG. 6 is a rear elevation view of the wedge of FIG. 1.

FIG. 7 is a front elevation view of the wedge of FIG. 6.

FIG. 8 is a right side elevation view of the wedge of FIG. 6

### DETAILED DESCRIPTION

All references cited herein are incorporated herein in their entireties. If there is a conflict between a definition herein and in an incorporated reference, the definition herein shall control.

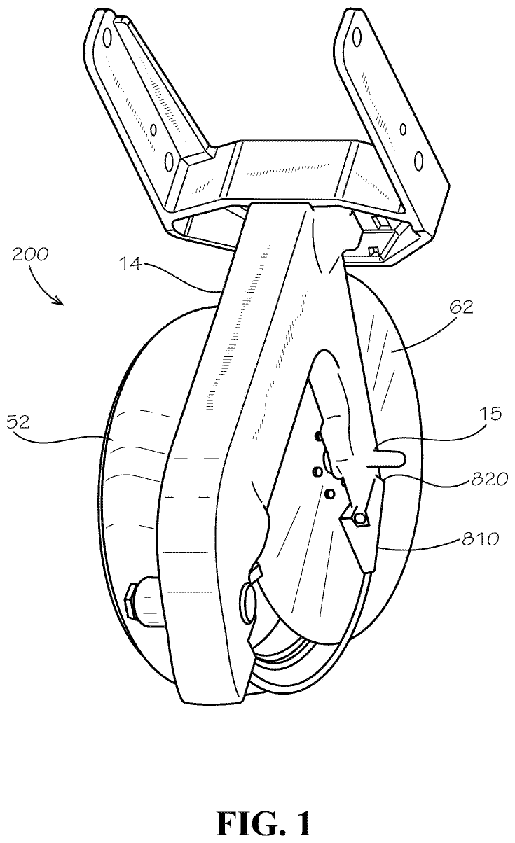

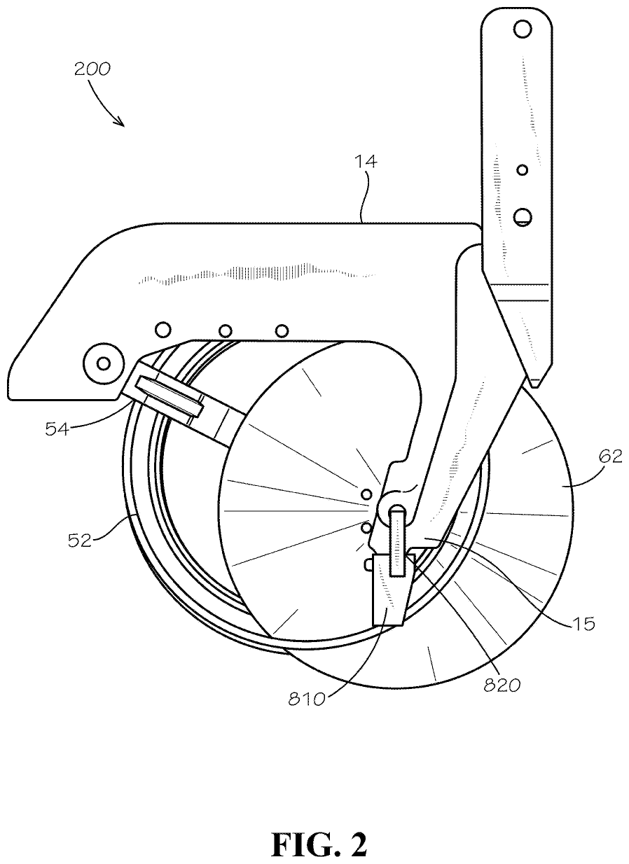

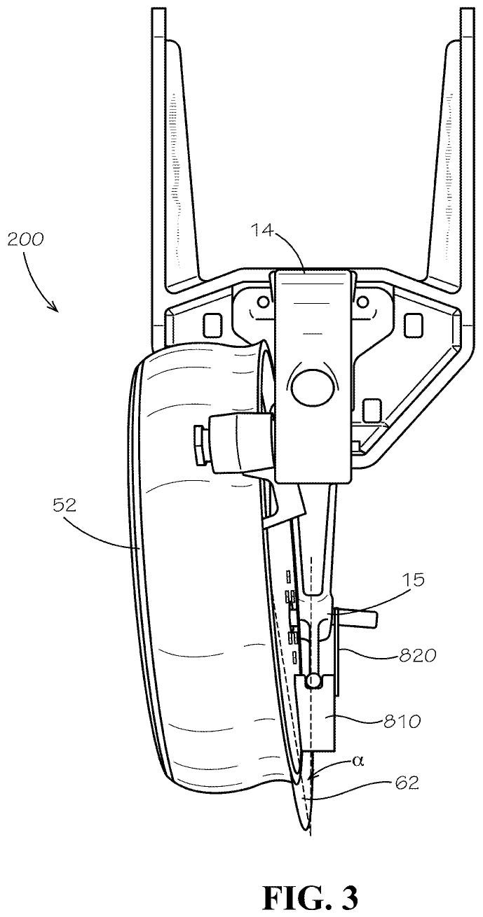

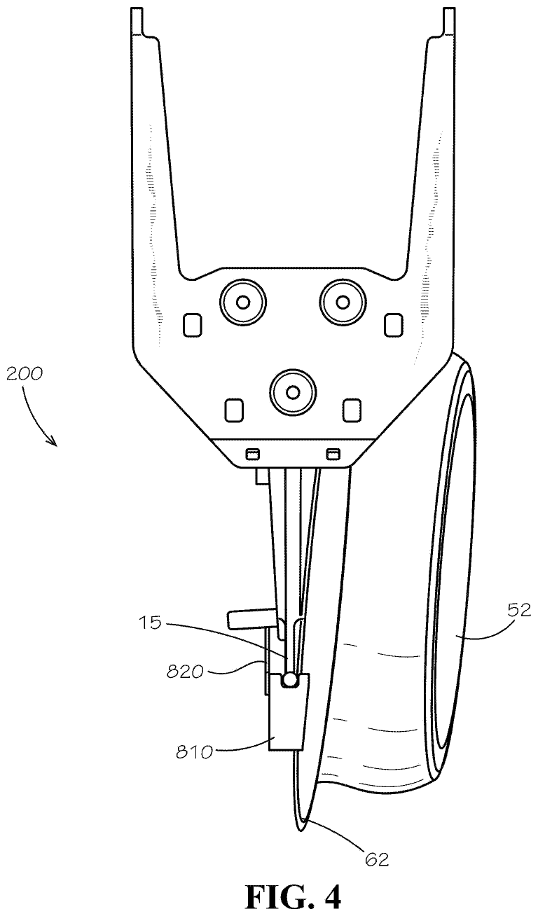

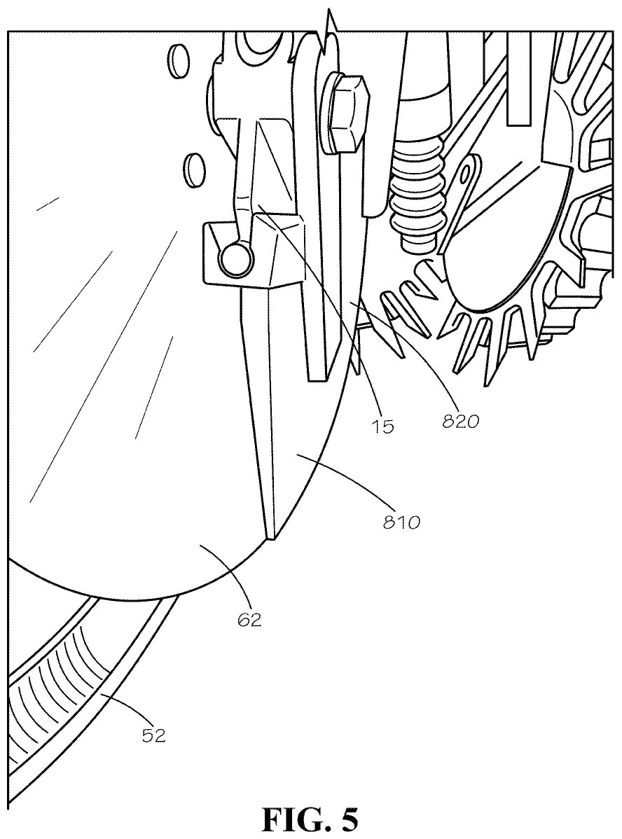

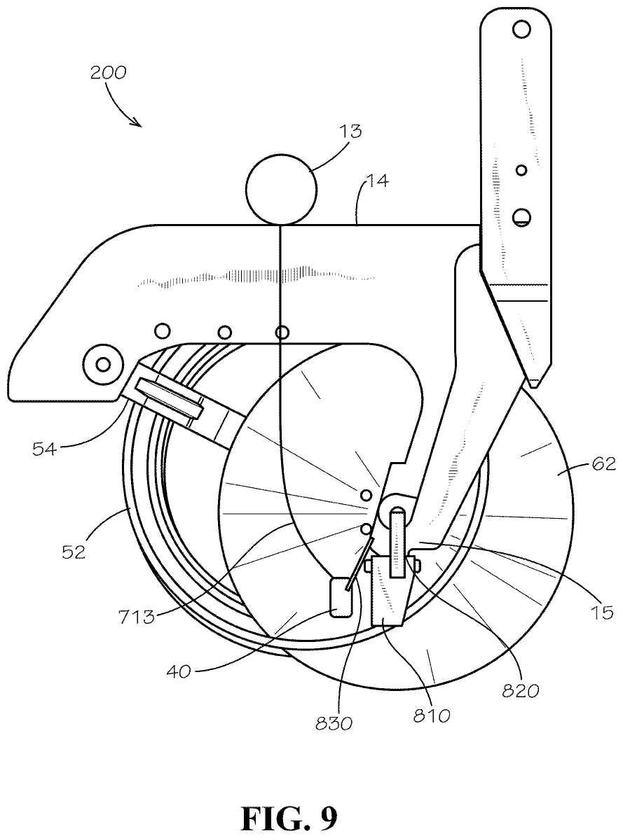

Referring to the drawings, wherein like reference numerals designate identical or corresponding parts throughout the several views, FIGS. 1 to 8 illustrate a disc and wedge opener.

As illustrated in FIGS. 1-4, row unit 200 has a frame 14 and a shank 15. Gauge wheel 52 is attached to frame 14 via gauge wheel arm 54. Disc 62 is rotatably attached to shank 15. Disc 62 is angled with to vertical with angle α. Angle α is greater than zero degrees such that disc 62 is not vertical. Angle α is greater than zero up to about 10°. In other embodiments, angle α is greater than zero up to about 6°, or about 1° to about 6°. Examples of row units can be found in PCT Publication Nos. WO2012/129442A2, WO2013/022835A1, WO2016/077651A1, and WO2017/143125A1.

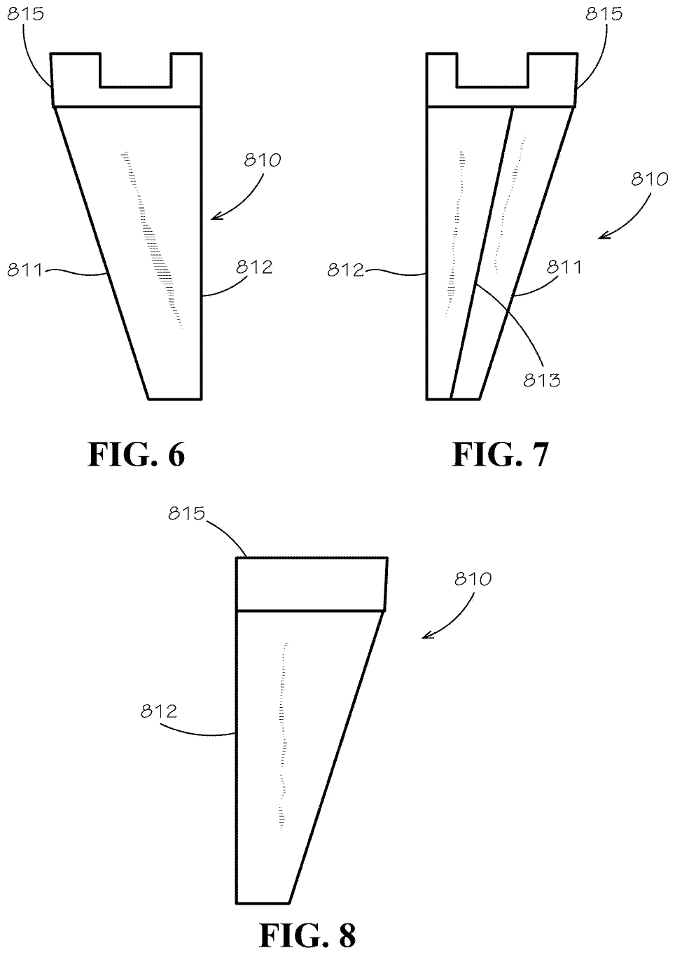

Wedge 810 is disposed adjacent to disc 62. Wedge 810 is illustrated in FIGS. 6-8. Wedge 810 can be connected to shank 15 with bracket 820. Also, wedge 810 can optionally have channel 815 to slidingly engage shank 15. Wedge 810 has disc facing side 811, which remains parallel with disc 62. Wedge 810 has opposing side 812 opposite disc facing side 811, which is perpendicular to the ground. Wedge 810 has a leading edge 813. Optionally, leading edge 813 can be knife shaped.

Disc 62 in combination with wedge 810 can provide a narrower trench as compared to double disc openers, single disc openers, or typical seed boots. Having a narrower trench allows for a seed to be placed into the trench in the same orientation as it was placed because there is less room for the seed to be moved once it is placed in the furrow. This can be a benefit when placing oriented seeds.

Examples of orientation systems include U.S. Provisional Application Nos. 63/262,360, filed 11 Oct. 2021; 63/262,361, filed 11 Oct. 2021; and 63/262,362, filed 11 Oct. 2021, and PCT Publication Nos. WO2018013858A1, WO2018013859A1, WO2018013860A2, and WO2018013861A1. One particular seed orienter is described in U.S. Patent Publication No. US2020/0367425A1. Examples of acceleration wheels described in Application Nos. 63/262,361 and 63/262,362 are described in PCT Publication Nos. WO2013/049198, WO2014/018717, and WO2017/011675, and which are available in the SpeedTube™ system from Precision Planting LLC of Tremont, Illinois.

FIG. 9 illustrates seed orientation seed orientation coil assembly 40 from US2020/0367425A1 receiving seed from conduit 713 dispensed from seed meter 13 and dispensing seed into the trench behind wedge 810. Seed orientation coil assembly 40 can be attached to shank 15 via bracket 830 or to frame 14 via bracket 830 (not illustrated).

An example of a seed meter 13 is described in PCT Publication Nos. WO2012/129442, WO2016/077651, and WO2007/024646.

### EXAMPLES

The following are nonlimiting examples.

Example 1—a trench opener comprising: a row unit comprising a frame and a shank; a disc rotatingly attached to the frame, wherein the disc has an angle α from vertical greater than zero degrees to 10 degrees; a wedge attached to the shank, the wedge having a disc facing side that is parallel with the disc, a second side opposite the disc facing side, wherein the second side is perpendicular to a ground surface, and a leading edge.

Example 2—the trench opener of claim 1 wherein the leading edge is knife shaped.

Example 3—the trench opener of any preceding claim, wherein angle α is 1 to 6 degrees.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A trench opener comprising:
a row unit comprising a frame and a shank;
a disc rotatingly attached to the frame, wherein the disc has an angle α from vertical greater than zero degrees to 10 degrees;
a wedge attached to the shank, the wedge having a disc facing side that is parallel with the disc, a second side opposite the disc facing side, wherein the second side is perpendicular to a ground surface, and a leading edge.

2. The trench opener of claim 1 wherein the leading edge is knife shaped.

3. The trench opener of claim 1, wherein angle α is 1 to 6 degrees.
